(19) United States
(12) Patent Application Publication
(10) Pub. No.: US 2026/0227538 A1
(43) Pub. Date: Aug. 6, 2026

(54) PLUME TRACKING USING SURFACE-BASED SOURCE-RECEIVER PAIR

(71) Applicant: Schlumberger Technology Corporation, Sugar Land, TX (US)

(72) Inventors: Joel Herve Le Calvez, Sugar Land, TX (US); Pierre Bettinelli, KUALA LUMPUR (MY)

(21) Appl. No.: 19/453,649

(22) Filed: Jan. 20, 2026

Related U.S. Application Data
(60) Provisional application No. 63/748,015, filed on Jan. 22, 2025.

(51) Int. Cl. G01V 1/30

(52) U.S. Cl. CPC G01V 1/301; G01V 2210/1295; G01V 2210/1425; G01V 2210/646

(57) ABSTRACT

A system and method that includes the use, over both space and time domains, of a single pair source-receiver to map in a focused manner at a very low operational and processing cost, the change in ‘fluid’ content at a specific location. The source-receiver may include multiple embodiments including a single source with multiple receivers, multiple sources with multiple receivers, or multiple sources with a single receiver.

### CROSS-REFERENCE TO RELATED APPLICATIONS

The present application claims priority to United States Provisional Application 63/748015 dated January 22, 2025, the entirety of which is incorporated by reference.

### FIELD OF THE DISCLOSURE

Aspects of the disclosure relate to plume tracking. More specifically, aspects of the disclosure relate to plume tracking in geological structures through use of surface-based source and receiver pairs.

### BACKGROUND

Hydraulic fracturing for stimulation of conventional reservoirs consists of the injection of a high viscosity fracturing fluid at high flow rate to open and then propagate a bi-wing tensile fracture in a geological formation. With the exception of the near wellbore region where a complex state of stress might develop, it is expected that this fracture will propagate normal to the far field, least, compressive stress. The length of this tensile fracture can be several hundred meters in length during a fracturing treatment of several hours. The fracturing fluid typically contains proppants, which are well graded particles, which are added to the fluid to maintain the fracture open once the pumping is stopped and pressure is released. This creates a high conductivity drain in the formation. These particles may consist of sand grains or ceramic grains, in some embodiments. A fracture fully packed with proppants results. The production of the hydrocarbons will then occur through spaces in the proppant pack. The hydraulic conductivity of the fracture is given by the proppant pack permeability and the retained fracture width.

Hydraulic fracturing is also very successfully applied in very low permeability gas saturated formations (often called unconventional gas reservoirs). These formations include tight gas sandstones, coal bed methane, and gas shales. While the permeability of tight gas sandstones is of the order of hundreds of microDarcy, gas shale permeability is of the order of hundreds of nanoDarcies. These reservoirs cannot be produced without stimulation. In these formations, field observations of fracturing treatments do not always support the concept of the creation of the commonly accepted bi-wing tensile fracture. Mine-back experiments, information obtained from laterals drilled across previously hydraulically fractured zones, and the record of microseismic events during a stimulation treatment indicate the creation of a complex fracture network geometry. The actual cause of this complex pattern is not yet fully established. This is especially true in some shales where tensile natural fractures are not aligned with the current principal stress direction because they were created in an era where the stress directions were different. It is still assumed that the majority of the newly induced fractures propagate normal to the far field, least, compressive stress, creating the so called fracture “fairway”, though shear fractures, mainly through the reactivation of pre-existing discontinuities, bedding planes and natural faults.

Complex fracture patterns have significant consequences for the design of the fracturing treatment. The fracture width of each branch of this complex fracture network is smaller than that of a single fracture, and the conventionally used proppant might not be able to be transported to the entire length of the fracture network.

Shear displacement along pre-existing discontinuities or even induced shear fractures might occur, which in turn, due to dilatancy effects, will increase the fracture conductivity without the need for the fracture to be fully propped. Finally, the pressure response during the treatment might be very different from that of a bi-wing fracture.

The current approach to estimate the production following the stimulation treatment in a complex reservoir where a fracture fairway has been created is to assume that the stimulation has created an enhanced permeability zone of about the size of a micro-seismicity cloud, the so called estimated stimulated zone (“ESV”). The ESV is defined as the reservoir volume, which has been contacted by the stimulation treatment, as determined by the microseismic event location and density. The ESV is not necessarily linked to an enhanced permeability zone. The actual conductive zone may be much smaller than the ESV because the proppant was not transported very far from the wellbore. Fracture complexity creates pinch points which restrict proppant transport. Use of incorrect viscosity fluid with poor transport properties compounds the problem of poor proppant placement. It is also not clear whether unpropped fractures can be conductive, especially if the amount of shear along the fracture plane is limited. Consequently, the obtained production estimated on the ESV is not based on sound measurement of a conductive zone. Using conventional methods and apparatus, proper evaluation of the efficiency of the stimulation treatment is difficult and incomplete. There is also a need for optimizing stimulation treatments.

There is a need to develop a technique which provides some estimate of the fractured zone which was propped or at least retained some conductivity.

Similarly, techniques are needed for evaluating large scale carbon capture projects. In these projects, fluid injections may be performed to enhance storage capability. Carbon dioxide, in a critical state, may be injected into a formation. This injection may include proppants to assist in maintaining crack dimensions. There is a need to be able to track and document plume activity in the subterranean environment to satisfy both engineering and regulatory requirements. As such project may extend into long-term deep reservoirs, there is a need to measure, monitor and verify conditions for the long term. Ensuring personnel safety and field integrity through caprock evaluation is critical to future operational requirements.

There is a need to provide an apparatus and methods that are both easier to operate than conventional apparatus and methods as well as easily understood such that extensive training is not needed by field personnel.

There is a still further need to reduce economic costs associated with operations and apparatus described above with conventional tools and methods.

### SUMMARY

So that the manner in which the above recited features of the present disclosure can be understood in detail, a more particular description of the disclosure, briefly summarized below, may be had by reference to embodiments, some of which are illustrated in the drawings. It is to be noted that the drawings illustrate only typical embodiments of this disclosure and are; therefore, not to be considered limiting of its scope, for the disclosure may admit to other equally effective embodiments without specific recitation. Accordingly, the following summary provides just a few aspects of the description and should not be used to limit the described embodiments to a single concept.

In one example embodiment, a method is disclosed. The method may comprise i) installing a source at a first location. The method may further comprise ii) installing a receiver at a second location. The method may further comprise iii) activating/shooting the source to produce a signal at least one time from the first location through at least one geological stratum to the second location. The method may further comprise iv) measuring travel time at time one (T1) for the signal traveling from the first location to the second location. The method may further comprise v) repeating step (iii) to produce a second signal and measuring travel time at time two (T2) of the travel of the second signal from the first location to the second location. The method may further comprise vi) changing the source to a third location. The method may further comprise vii) changing the receiver to a fourth location. The method may further comprise viii) activating/shooting the source at least one time to produce a third signal from the third location to the fourth location. The method may further comprise ix) measuring travel time of the third signal at time three (T3) from the third location to the fourth location. The method may further comprise x) repeating step (viii) and measuring travel time at time four (T4) from the third location to the fourth location via the activating/shooting the source of step (viii).

In another example embodiment, a system is described. The system may comprise a processor, a memory accessible to the processor, and processor-executable instructions stored in the memory and executable by the processor to instruct the system. The instructions may comprise i) installing a source at a first location. The instructions may further comprise ii) installing a receiver at a second location. The instructions may further comprise iii) activating/shooting the source to produce a signal at least one time from the first location through at least one geological stratum to the second location. The instructions may further comprise iv) measuring travel time at time one (T1) for the signal traveling from the first location to the second location. The instructions may further comprise v) repeating step (iii) to produce a second signal and measuring travel time at time two (T2) of the travel of the second signal from the first location to the second location. The instructions may further comprise vi) changing the source to a third location. The instructions may further comprise vii) changing the receiver to a fourth location. The instructions may further comprise viii) activating/shooting the source at least one time to produce a third signal from the third location to the fourth location. The instructions may further comprise ix) measuring travel time of the third signal at time three (T3) from the third location to the fourth location. The instructions may further comprise x) repeating step (viii) and measuring travel time at time four (T4) from the third location to the fourth location via the activating/shooting the source of step (viii).

In another example embodiment, a method is disclosed. The method may comprise i) placing a sound transmitter at a first location at a surface of a geological formation. The method may further comprise ii) installing a sound receiver at a second location at the surface of the geological formation. The method may further comprise iii) activating/shooting the sound transmitter to produce a first acoustic signal into the geological stratum. The method may further comprise iv) receiving the first acoustic signal at the second location. The method may further comprise v) measuring a travel time at time one (T1) for the first signal traveling from the first location to the second location. The method may further comprise vi) repeating step (iii) to produce a second acoustic signal and measuring a travel time at time two (T2) of the travel of the second acoustic signal from the first location to the second location. The method may further comprise vii) placing the transmitter at a third location. The method may further comprise viii) placing the receiver to a fourth location. The method may further comprise ix) activating/shooting the source at least one time to produce a third acoustic signal from the third location to the fourth location. The method may further comprise x) receiving the third acoustic signal. The method may further comprise xi) measuring travel time of the third acoustic signal at time three (T3) from the third location to the fourth location. The method may further comprise xii) repeating step (ix) and measuring travel time at time four (T4) from the third location to the fourth location via the activating/shooting the source of step (ix).

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the drawings. It is to be noted; however, that the appended drawings illustrate only typical embodiments of this disclosure and are; therefore, not be considered limiting of its scope, for the disclosure may admit to other equally effective embodiments.

FIG. 1 is a diagram illustrating a configuration at time one (T1), according to one or more embodiments of the disclosure.

FIG. 2 is a diagram illustrating a configuration at time two (T2), according to one or more embodiments of the disclosure.

FIG. 3 is a diagram illustrating a configuration at time three (T3), according to one or more embodiments of the disclosure.

FIG. 4 is a diagram illustrating a configuration at time four (T4), according to one or more embodiments of the disclosure.

FIG. 5 is a method of one example embodiment of the disclosure.

To facilitate understanding, identical reference numerals have been used, where possible, to designate identical elements that are common to the figures(“FIGS”). It is contemplated that elements disclosed in one embodiment may be beneficially utilized on other embodiments without specific recitation.

### DETAILED DESCRIPTION

In the following, reference is made to embodiments of the disclosure. It should be understood; however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the claims except where explicitly recited in a claim. Likewise, reference to “the disclosure” shall not be construed as a generalization of inventive subject matter disclosed herein and should not be considered to be an element or limitation of the claims except where explicitly recited in a claim.

Although the terms first, second, third, etc., may be used herein to describe various elements, components, regions, layers, and/or sections, these elements, components, regions, layers, and/or sections should not be limited by these terms. These terms may be only used to distinguish one element, components, region, layer, or section from another region, layer, or section. Terms such as “first”, “second” and other numerical terms, when used herein, do not imply a sequence or order unless clearly indicated by the context. Thus, a first element, component, region, layer, or section discussed herein could be termed a second element, component, region, layer, or section without departing from the teachings of the example embodiments.

When an element or layer is referred to as being “on”, “engaged to”, “connected to”, or “coupled to” another element or layer, it may be directly on, engaged, connected, or coupled to the other element or layer, or interleaving elements or layers may be present. In contrast, when an element is referred to as being “directly on”, “directly engaged to”, “directly connected to”, or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

Some embodiments will now be described with reference to the figures. Like elements in the various figures will be referenced with like numbers for consistency. In the following description, numerous details are set forth to provide an understanding of various embodiments and/or features. It will be understood; however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to more clearly describe certain embodiments.

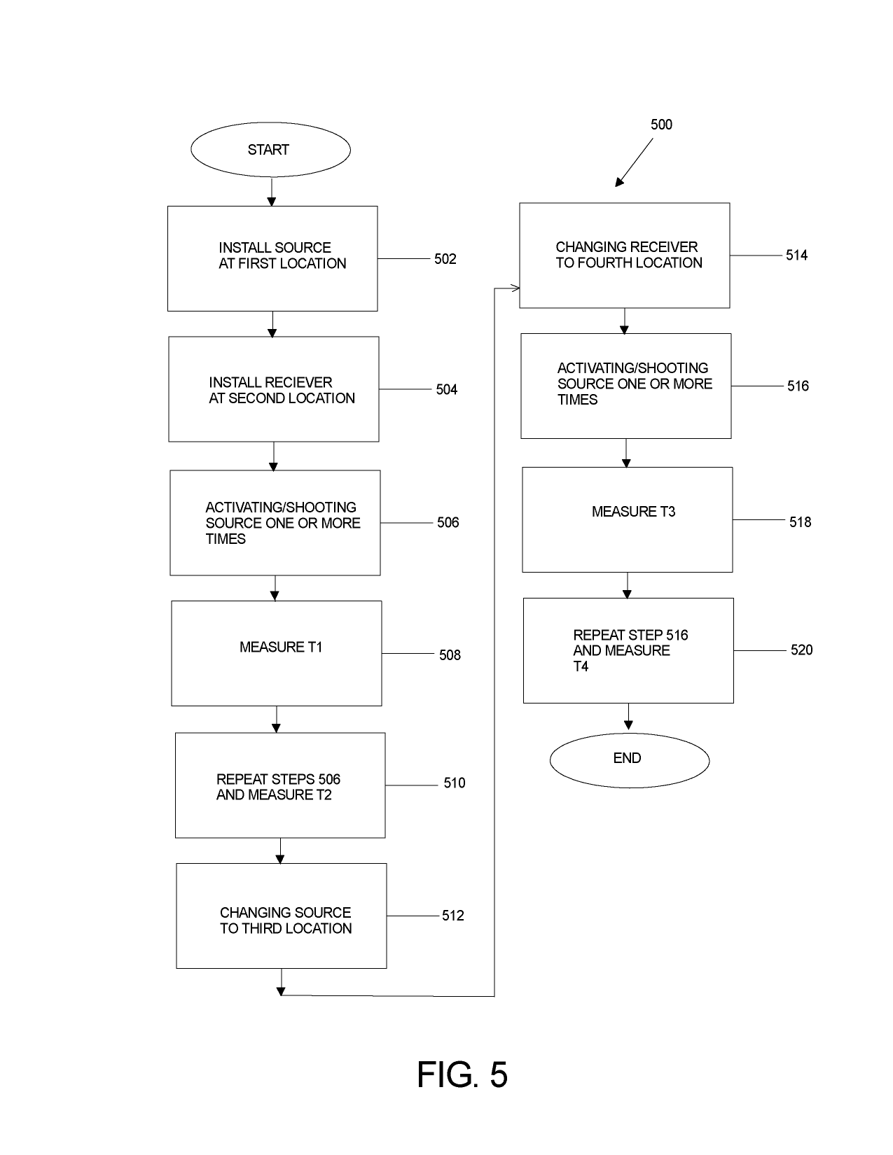

Presently disclosed embodiments may include a method for plume tracking in a geological stratum. Referring to FIG. 5, the method 500, includes, at 502, installing a source at a first location. The method may further include, at 504, installing a receiver at a second location. The method may further include, at 506, activating/shooting the source one or more times from the first location to the second location. The method may further include, at 508, measuring travel time at time one (T1) from the first location to the second location via the activating/shooting the source. The method may further include, at 510, repeating steps 506 and measuring travel time at time two (T2) from the first location to the second location via the activating/shooting the source. The method may further include, at 512, changing the source to a third location. The method may further include, at 514, changing the receiver to a fourth location. The method may further include, at 516, activating/shooting the source one or more times from the third location to the fourth location. The method may further include, at 518, measuring travel time at time three (T3) from the third location to the fourth location via the activating/shooting the source of step 516. The method may further include, at 520, repeating step 516 and measuring travel time at time four (T4) from the third location to the fourth location via the activating/shooting the source of step 516.

The presently disclosed embodiments may include repeating steps 502 to 518 to measure more travel times. The presently disclosed embodiments may include a system including a processor, memory accessible to the processor, processor-executable instructions stored in the memory and executable by the processor to instruct the system to: i) install a source at a first location, ii) install a receiver at a second location, iii) activate/shoot the source one or more times from the first location to the second location, iv) measure travel time at time one (T1) from the first location to the second location via the activating/shooting the source, v) repeat steps (iii) and measure travel time at time two (T2) from the first location to the second location via the activating/shooting the source, vi) change the source to a third location, vii) change the receiver to a fourth location, viii) activate/shoot the source one or more times from the third location to the fourth location, ix) measure travel time at time three (T3) from the third location to the fourth location via the activating/shooting the source of step (viii), and x) repeat step (viii) and measure travel time at time four (T4) from the third location to the fourth location via the activating/shooting the source of step (viii).

Aspects of the present disclosure relate to the use over the two domains space and time of a single pair source-receiver to map plumes. The mapping may be accomplished in a focused manner at a very low operational and processing cost. Aspects evaluate the change in ‘fluid’ content at a specific location. In embodiments, the source receiver pair may be configured in multiple ways, such as single source-single receiver, single source – multiple receivers, multiple sources – multiple receivers, or multiple sources – single receiver.

The specific location to be observed or ’point of interest’, is chosen based on careful analysis of the dynamic fluid behavior of the reservoir model. As such, the survey is designed to confirm the possible changes of fluid content at the point of interests.

Aspects of the disclosure may be combined with aspects of tomography, which is a more complex, more complete, more time consuming and more expensive (in terms of acquisition and processing) way to image the formation and its potential changes over time if performed over a period of time.

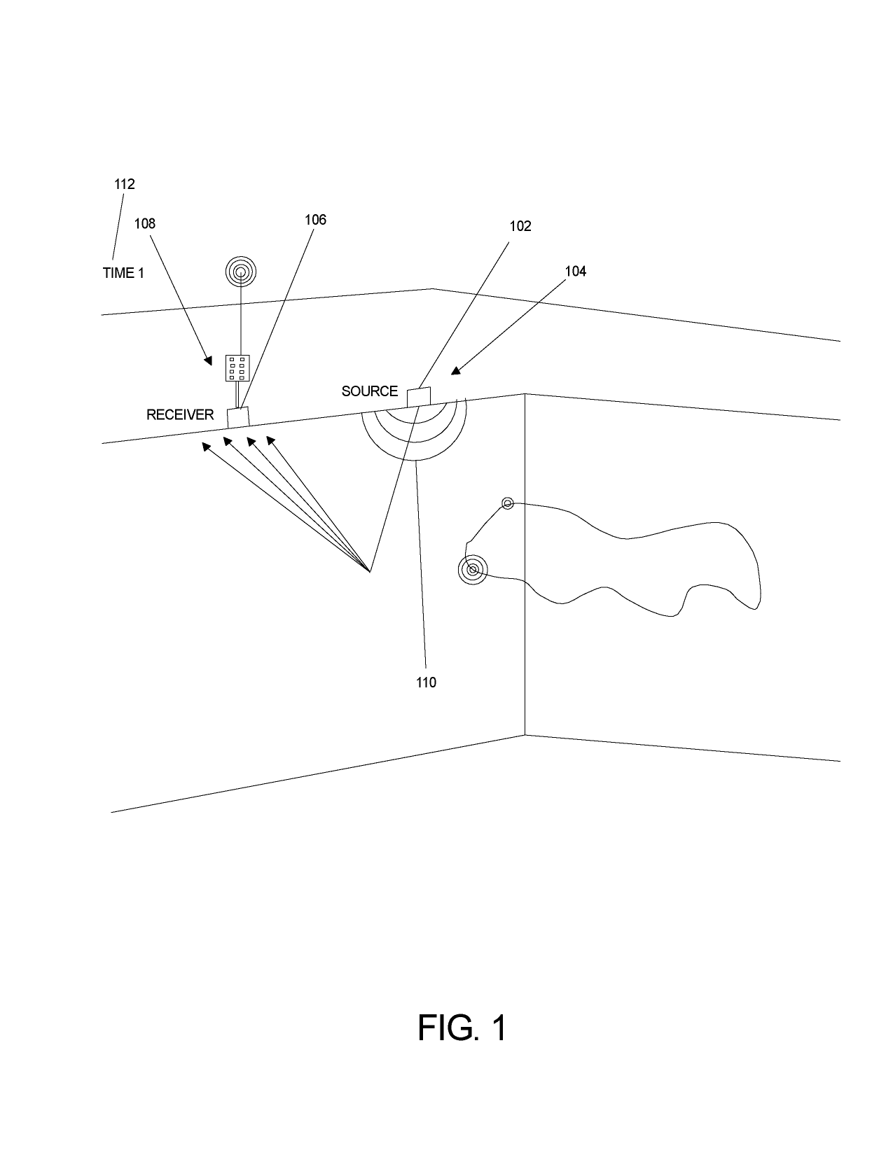

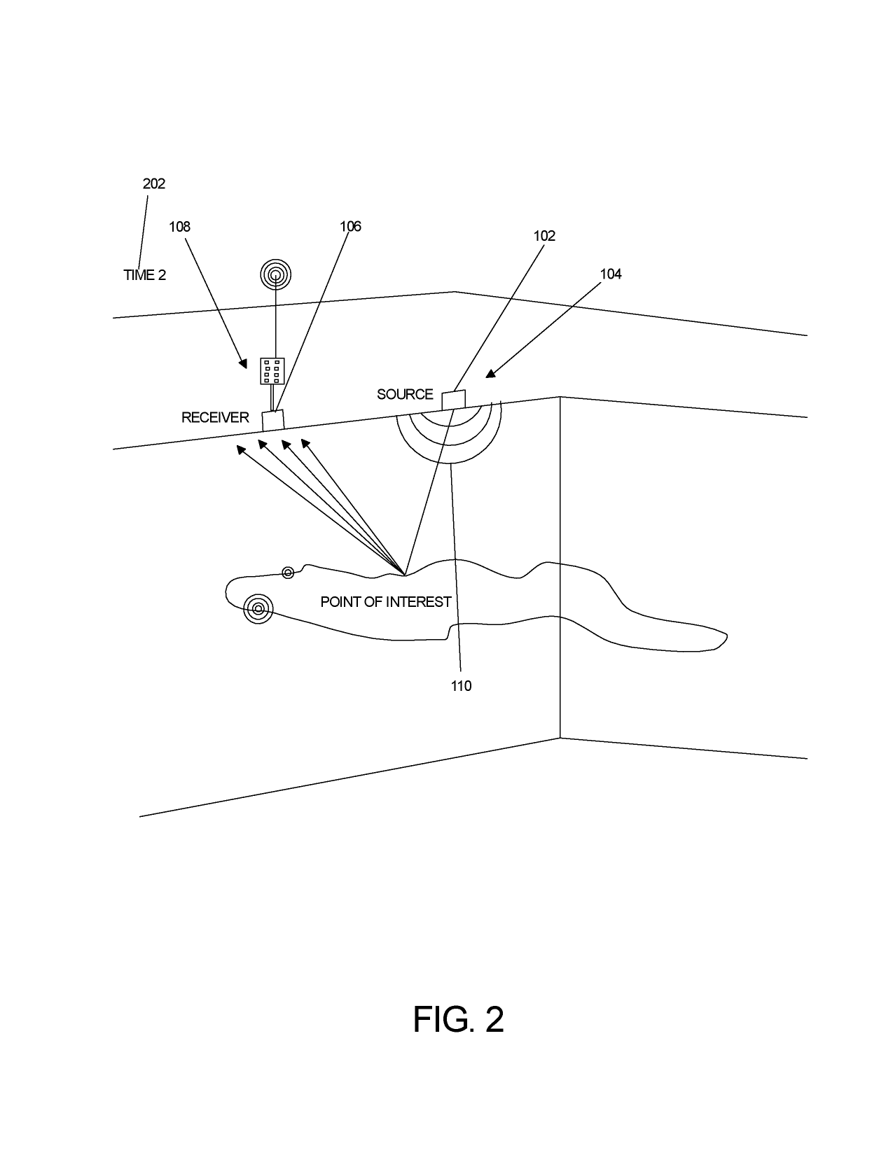

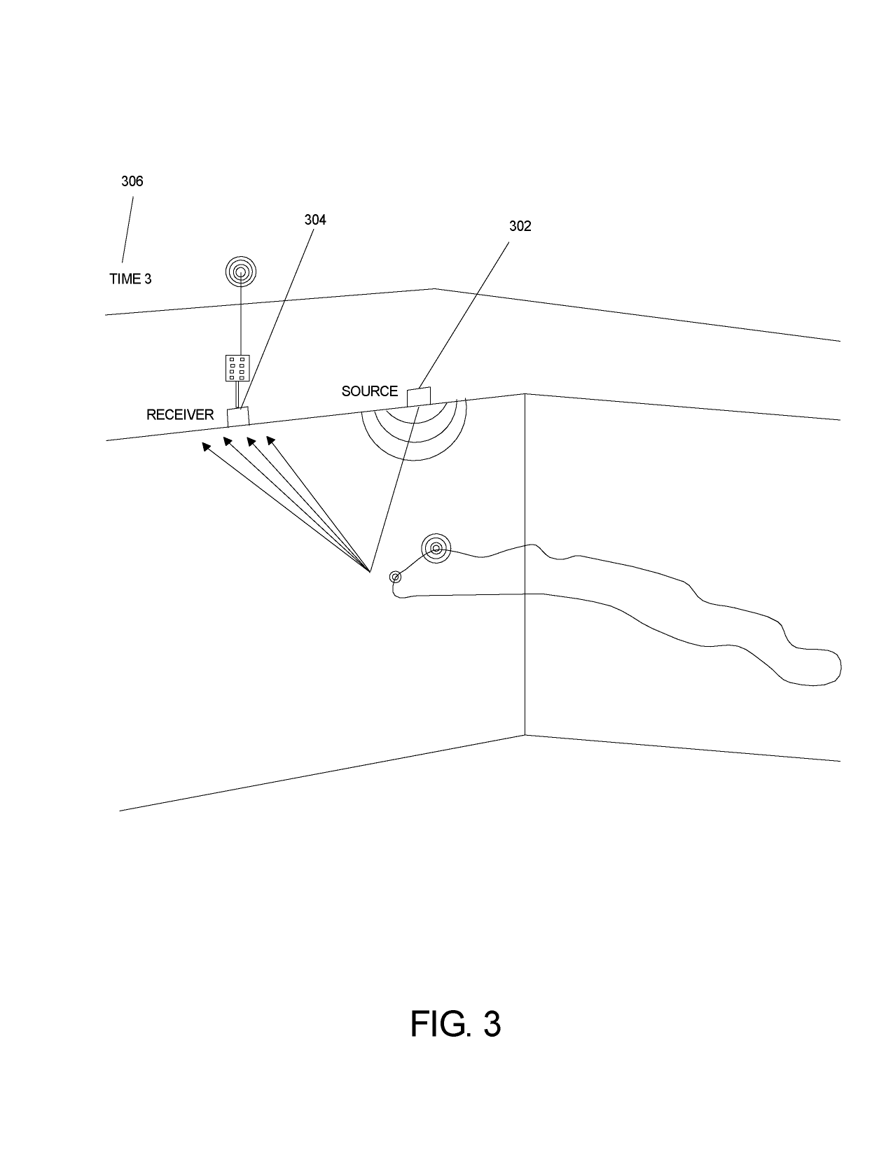

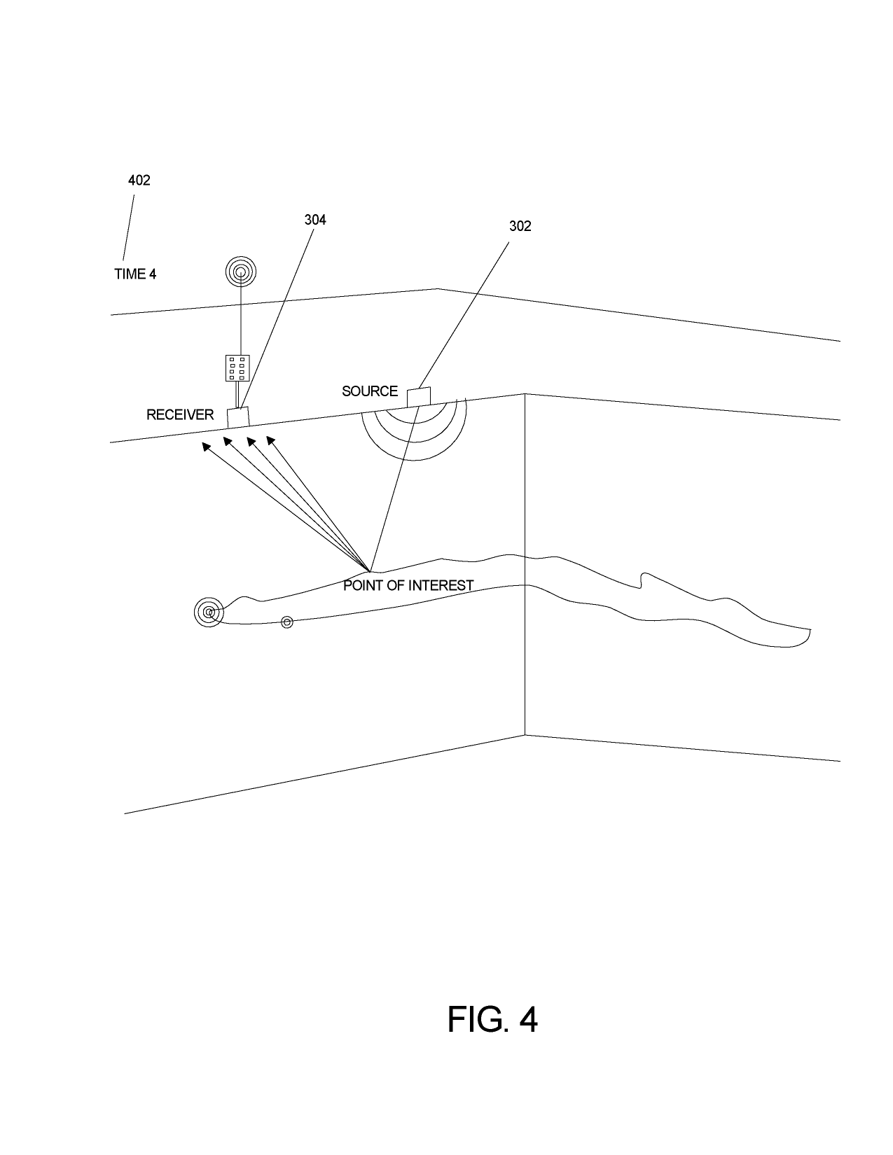

Referring to FIGS. 1 to 4, an embodiment of the present disclosure is illustrated. They may comprise of several steps such as:
a. Step 1 - Installing a source [S] 102 (compressive and/or shear, remote controlled or not, with GPS time stamp or not) at location (SX1, SY1, SZ1) 104.
b. Step 2 - Installing a receiver [R] 106 (1C and/or 3C) at location (RX1, RY1, RZ1) 108.
c. Step 3 - Activating/shooting the source one or more times to produce a signal 110 and measure travel time between [S] and [R] to get travel time TWT1 at time 1 (T1) 112.
d. Step 4 - Using the same monitoring configuration [S1] 102 and [R1]106, repeat at T2202 to get TWT2 (see FIG. 2).
If TWT2 equals TWT1 then formation content has not changed between T1 and T2.
If TWT2 is different from TWT1 then formation content has changed between T1 and T2.
e. Step 5 - To track potential edge/change of volume extent of fluid body/cloud, changing source location to S2302 and receiver location 304 to R2 and activating/shooting the source to emit a signal to get TWT3 (see FIG. 3).
f. Step 6 - Using the same monitoring configuration [S2] 302 and [R2],304 repeat at T4 to get TWT4402 (see FIG. 4).
If TWT4 equals TWT3 then formation content has not changed between T3 and T4.
If TWT4 is different from TWT3 then formation content has changed between T3 and T4.
g. And repeating as needed over T.

Examples in the present disclosure may also be directed to a non-transitory, computer-readable medium, storing, computer-executable, instructions and executable by one or more processors of the computer via which the computer-readable medium is accessed. A computer-readable media may be any available media that may be accessed by a computer. By way of example, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Further embodiments may include methodologies that allow computers to be trained to allow for more comprehensive and accurate answers. Such training may be performed in nodes that may be used to allow for fine tuning of results. Upon retention of results of calculations, the method steps may be altered such that results that are not accurate are precluded from future calculations by amending method steps accomplished in various nodes. Such alterations are contemplated and are within the scope of this disclosure.

Further embodiments may be automated such that the number of field activities that have to be performed by field personnel is minimized. Robotic control of apparatus as well as remote control from a data center are contemplated. Repeated activities can be performed with the help of artificial intelligence. Such artificial intelligence may allow for evaluation of data on an automated basis. Further embodiments may store information or retrieve information for data sources in order to track plume movement over time. In embodiments, permanently installed sources and receivers may be used in embodiments of the disclosure. Such permanently installed sources and receivers can be used to monitor long term tracking of plumes.

One embodiment of the present disclosure is particularly applicable to tracking the movement of hydrocarbons within a geological stratum or across an arrangement of different geological strata. This technique is beneficial in scenarios where fluid injection is utilized to mobilize hydrocarbons, such as in enhanced oil recovery operations, as well as in situations where natural flow occurs due to the pumping of hydrocarbons from within the area. By monitoring changes in travel time between specific source and receiver locations over time, it is possible to detect alterations in formation content, thereby enabling effective tracking of hydrocarbon migration within the subsurface environment.

Another embodiment of the disclosure is directed toward contaminant monitoring, which can play a crucial role in environmental management and protection. This approach is not limited to a single type of contaminant but may be used to monitor a range of issues, including heavy metal contamination, organic pollutant migration, salt water intrusion, or other fluid movements within geological formations. The ability to detect and track such changes allows for timely intervention and remediation, helping to safeguard groundwater resources and maintain the integrity of the subsurface environment. As will be understood, the spread of a plume of fluid through a geological stratum or an arrangement of different stratums can occur with any type of fluid through any type of stratum. To this end, the aspects of the disclosure are not limited to hydraulic fracturing embodiments.

Aspects of claims in the application are described next. The description of these claims should not be considered limiting. In one example embodiment, a method is disclosed. The method may comprise i) installing a source at a first location. The method may further comprise ii) installing a receiver at a second location. The method may further comprise iii) activating/shooting the source to produce a signal at least one time from the first location through at least one geological stratum to the second location. The method may further comprise iv) measuring travel time at time one (T1) for the signal traveling from the first location to the second location. The method may further comprise v) repeating step (iii) to produce a second signal and measuring travel time at time two (T2) of the travel of the second signal from the first location to the second location. The method may further comprise vi) changing the source to a third location. The method may further comprise vii) changing the receiver to a fourth location. The method may further comprise viii) activating/shooting the source at least one time to produce a third signal from the third location to the fourth location. The method may further comprise ix) measuring travel time of the third signal at time three (T3) from the third location to the fourth location. The method may further comprise x) repeating step (viii) and measuring travel time at time four (T4) from the third location to the fourth location via the activating/shooting the source of step (viii).

In another example embodiment, the method may be performed wherein steps (i) to (ix) are repeated to measure more travel times.

In another example embodiment, the method may further comprise comparing times T1, T2, T3 and T4.

In another example embodiment, the method may further comprise storing times T1, T2, T3 and T4.

In another example embodiment, the method may further comprise graphically representing each time measurement.

In another example embodiment, the method may be performed wherein the source includes at least two sources.

In another example embodiment, the method may be performed wherein the receiver includes at least two receivers.

In another example embodiment, a system is described. The system may comprise a processor, a memory accessible to the processor, and processor-executable instructions stored in the memory and executable by the processor to instruct the system. The instructions may comprise i) installing a source at a first location. The instructions may further comprise ii) installing a receiver at a second location. The instructions may further comprise iii) activating/shooting the source to produce a signal at least one time from the first location through at least one geological stratum to the second location. The instructions may further comprise iv) measuring travel time at time one (T1) for the signal traveling from the first location to the second location. The instructions may further comprise v) repeating step (iii) to produce a second signal and measuring travel time at time two (T2) of the travel of the second signal from the first location to the second location. The instructions may further comprise vi) changing the source to a third location. The instructions may further comprise vii) changing the receiver to a fourth location. The instructions may further comprise viii) activating/shooting the source at least one time to produce a third signal from the third location to the fourth location. The instructions may further comprise ix) measuring travel time of the third signal at time three (T3) from the third location to the fourth location. The instructions may further comprise x) repeating step (viii) and measuring travel time at time four (T4) from the third location to the fourth location via the activating/shooting the source of step (viii).

In another example embodiment, the system takes a form of one of a solid-state device, a laptop computer, a desktop computer, a universal serial bus device, and a flash card device.

In another example embodiment, a method is disclosed. The method may comprise i) placing a sound transmitter at a first location at a surface of a geological formation. The method may further comprise ii) installing a sound receiver at a second location at the surface of the geological formation. The method may further comprise iii) activating/shooting the sound transmitter to produce a first acoustic signal into the geological stratum. The method may further comprise iv) receiving the first acoustic signal at the second location. The method may further comprise v) measuring a travel time at time one (T1) for the first signal traveling from the first location to the second location. The method may further comprise vi) repeating step (iii) to produce a second acoustic signal and measuring a travel time at time two (T2) of the travel of the second acoustic signal from the first location to the second location. The method may further comprise vii) placing the transmitter at a third location. The method may further comprise viii) placing the receiver to a fourth location. The method may further comprise ix) activating/shooting the source at least one time to produce a third acoustic signal from the third location to the fourth location. The method may further comprise x) receiving the third acoustic signal. The method may further comprise xi) measuring travel time of the third acoustic signal at time three (T3) from the third location to the fourth location. The method may further comprise xii) repeating step (ix) and measuring travel time at time four (T4) from the third location to the fourth location via the activating/shooting the source of step (ix).

In another example embodiment, the method may further comprise comparing times T1, T2, T3 and T4.

In another example embodiment, the method may further comprise storing times T1, T2, T3 and T4.

In another example embodiment, the method may further comprise graphically representing each time measurement.

In another example embodiment, the method may be performed wherein the source includes at least two sources.

In another example embodiment, the method may be performed wherein the receiver includes at least two receivers.

In another example embodiment, the method may further comprise transmitting times T1, T2, T3 and T4 to a remote location for processing; and determining a position of a plume within the geological stratum from the times T1, T2, T3 and T4.

In another example embodiment, the method may be performed wherein the activating/shooting of the sound transducer includes producing more than one signal.

In another example embodiment, the method may be performed wherein the receiving includes receiving more than one signal.

In another example embodiment, the method may be performed wherein the transmitters and receivers are acoustic transducers.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may be varied in many ways. Such variations are not to be regarded as a departure from the disclosure, and all such modifications are intended to be included within the scope of the disclosure.

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

What is claimed is:

1. A method comprising:
i) installing a source at a first location;
ii) installing a receiver at a second location;
iii) activating/shooting the source to produce a signal at least one time from the first location through at least one geological stratum to the second location;
iv) measuring travel time at time one (T1) for the signal traveling from the first location to the second location;
v) repeating step (iii) to produce a second signal and measuring travel time at time two (T2) of the travel of the second signal from the first location to the second location;
vi) changing the source to a third location;
vii) changing the receiver to a fourth location;
viii) activating/shooting the source at least one time to produce a third signal from the third location to the fourth location;
ix) measuring travel time of the third signal at time three (T3) from the third location to the fourth location; and
x) repeating step (viii) and measuring travel time at time four (T4) from the third location to the fourth location via the activating/shooting the source of step (viii).

2. The method of claim 1, wherein steps i) to ix) are repeated to measure more travel times.

3. The method according to claim 1, further comprising comparing times T1, T2, T3 and T4.

4. The method according to claim 3, further comprising storing times T1, T2, T3 and T4.

5. The method according to claim 3, further comprising graphically representing each time measurement.

6. The method according to claim 1, wherein the source includes at least two sources.

7. The method according to claim 1, wherein the receiver includes at least two receivers.

8. A system comprising:
a processor;
memory accessible to the processor;
processor-executable instructions stored in the memory and executable by the processor to instruct the system to:
i) installing a source at a first location;
ii) installing a receiver at a second location;
iii) activating/shooting the source to produce a signal at least one time from the first location through at least one geological stratum to the second location;
iv) measuring travel time at time one (T1) for the signal traveling from the first location to the second location;
v) repeating step (iii) to produce a second signal and measuring travel time at time two (T2) of the travel of the second signal from the first location to the second location;
vi) changing the source to a third location;
vii) changing the receiver to a fourth location;
viii) activating/shooting the source at least one time to produce a third signal from the third location to the fourth location;
ix) measuring travel time of the third signal at time three (T3) from the third location to the fourth location; and
x) repeating step (viii) and measuring travel time at time four (T4) from the third location to the fourth location via the activating/shooting the source of step (viii).

9. The system according to claim 8, wherein the system takes a form of one of a solid-state device, a laptop computer, a desktop computer, a universal serial bus device, and a flash card device.

10. A method comprising:
i) placing a sound transmitter at a first location at a surface of a geological formation;
ii) installing a sound receiver at a second location at the surface of the geological formation;
iii) activating/shooting the sound transmitter to produce a first acoustic signal into the geological stratum;
iv) receiving the first acoustic signal at the second location;
v) measuring a travel time at time one (T1) for the first signal traveling from the first location to the second location;
vi) repeating step (iii) to produce a second acoustic signal and measuring a travel time at time two (T2) of the travel of the second acoustic signal from the first location to the second location;
vii) placing the transmitter at a third location;
viii) placing the receiver to a fourth location;
ix) activating/shooting the source at least one time to produce a third acoustic signal from the third location to the fourth location;
x) receiving the third acoustic signal;
xi) measuring travel time of the third acoustic signal at time three (T3) from the third location to the fourth location; and
xii) repeating step (ix) and measuring travel time at time four (T4) from the third location to the fourth location via the activating/shooting the source of step (ix).

11. The method according to claim 10, further comprising comparing times T1, T2, T3 and T4.

12. The method according to claim 11, further comprising storing times T1, T2, T3 and T4.

13. The method according to claim 12, further comprising graphically representing each time measurement.

14. The method according to claim 10, wherein the source includes at least two sources.

15. The method according to claim 10, wherein the receiver includes at least two receivers.

16. The method according to claim 10, further comprising:
transmitting times T1, T2, T3 and T4 to a remote location for processing; and
determining a position of a plume within the geological stratum from the times T1, T2, T3 and T4.

17. The method according to claim 10, wherein the activating/shooting of the sound transducer includes producing more than one signal.

18. The method according to claim 17, wherein the receiving includes receiving more than one signal.

19. The method according to claim 10, wherein the transmitters and receivers are acoustic transducers.

20. The method according to claim 10, wherein at least one of the transmitters and receivers are acoustic transducers.
